(19) United States
(12) Patent Application Publication
(10) Pub. No.: US 2014/0127927 A1
(43) Pub. Date: May 8, 2014

(54) USB MALE END, USB FEMALE END AND USB PORT CONNECTION DEVICE

(71) Applicant: BOE TECHNOLOGY GROUP CO., LTD., Beijing (CN)

(72) Inventor: CHANGLIN LENG, Beijing (CN)

(73) Assignee: BOE TECHNOLOGY GROUP CO., LTD., Beijing (CN)

(21) Appl. No.: 14/069,905

(22) Filed: Nov. 1, 2013

(30) Foreign Application Priority Data
Nov. 5, 2012 (CN) 201220578122.5

(51) Int. Cl. H01R 13/62

(52) U.S. Cl. CPC H01R 13/6205
USPC 439/345

(57) ABSTRACT

Embodiments of the invention disclose a USB female end, a USB male end and a USB port connection device. The USB female end comprises a female end body (1) which comprises a receptacle (11), two solenoid switches (3), a switch, a signal acquisition unit (21) and a control unit (22). Each solenoid switch (3) controls a movable core (31) to protrude and pass through the through hole on side walls of the receptacle (11). The signal acquisition unit (21) generates a corresponding potential signal from potential information. The control unit (22) controls the switch to enable or disable the power supply of the solenoid switches (3). When the USB female and the USB male are connected, the movable cores (31) pass through the through holes and lock the USB male, thereby improving the firmness of the connection between the USB female end and the USB male end.

### TECHNICAL FIELD

Embodiments of the present invention relate to a USB male end, a USB female end and a USB port connection device.

### BACKGROUND

Currently, various connection ports are used on a computer device so as to facilitate the connection of several peripheral devices such as a mouse, a storage device or a display device and the like. There are many connection devices for the peripheral devices, among which USB port connection devices are widely used.

While it has to ensure the plugging-removing match between the female and male ends of the USB port connection devices, the requirement on the firmness of the fitting of the USB port connection device is relatively high as well, especially under the current USB 3.3 standard. With the conventional technologies, a USB male end is connected to a USB female end just by the interlocking between the USB male plug and the USB female receptacle, thereby confining the upward and downward movement of the USB male. Thus, such a connection is of poor stability and may easily cause intermittent USB power, which will further affect the reliability of the circuit.

### SUMMARY

Embodiments of the present invention provides a USB female end, a USB male end and a USB port connection device which may improve the firmness of the USB port connection device and ensure the reliability of the circuit when the USB female end is connected to the USB male end.

To achieve the above objective, embodiments of the invention provides a USB female end which comprises: a female end body, which comprising a receptacle; two solenoid switches respectively located on two opposite sides of the receptacle, each solenoid switch comprising at least one movable core; through holes disposed on side walls of the receptacle corresponding to said at least one movable core in one-to-one correspondence, each solenoid switch, when being energized, controlling said at least one movable core to protrude and pass through the through holes; a switch controlling ON/OFF of a power supply of the solenoid switches; a signal acquisition unit electrically connected to an interface power source of the USB female end, acquiring potential information of the interface power source of the USB female end and generating a corresponding potential signal; a control unit connected to the signal acquisition unit, controlling the switch to enable the power supply of the solenoid switches when the potential signal is a high potential signal or to disable the power supply of the solenoid switches when the potential signal is a low potential signal.

As an example, the signal acquisition unit comprises a first resistor and a second resistor, the control unit comprises a DVDD AND gate, and the switch is a MOS switch transistor. One terminal of the first resistor is electrically connected to the interface power source of the USB female end, the other terminal is electrically connected to one terminal of the second resistor and a first input of the AND gate, the output of the AND gate is electrically connected to the MOS switch transistor.

As an example, the control unit further comprises a Pulse Width Multiplier (PWM), which is electrically connected to a second input of the AND gate.

As an example, said at least one movable core comprises two pairs of movable cores, each cross section of a pair of movable cores is triangular, each cross section of the other pair of movable cores is circular. Through holes corresponding to the triangular cross-sectioned movable cores are triangular through holes, through holes corresponding to the circular cross-sectioned movable cores are circular through holes.

An embodiment of the invention further provides a USB male end used with the above USB female end, and the USB male end comprises: a male end body; The male end body further comprising a plug. Fixing holes in one-to-one correspondence with the through holes on the side walls of the receptacle are disposed on two side walls of the plug.

As an example, the fixing holes comprise two pairs of the fixing holes, one pair being triangular fixing holes, and the other pair being circular fixing holes.

As an example, the triangular fixing holes are through holes and the circular fixing holes are blind holes.

As an example, the two pairs of fixing holes are both blind holes.

An embodiment of the invention further provides a USB port connection device which comprises the above USB female end and the USB male end.

The device has good connection stability and ensures the reliability of the circuit.

### BRIEF DESCRIPTION OF THE DRAWINGS

In order to clearly illustrate the technical solution of the embodiments of the invention, the drawings of the embodiments will be briefly described in the following. It is obvious that the described drawings are only related to some embodiments of the invention and thus are not limitative of the invention.

FIG. 1 schematically illustrates a state of a USB female end not being connected to a USB male end in accordance with an embodiment of the invention;

FIG. 2 schematically illustrates a configuration of a solenoid switch in accordance with an embodiment of the invention;

FIG. 3 illustrates circuits of an acquisition unit and a control unit in accordance with an embodiment of the invention;

FIG. 4 schematically illustrates a configuration of a USB female end in accordance with an embodiment of the invention;

FIG. 5 schematically illustrates a configuration of a USB male end in accordance with an embodiment of the invention; and

FIG. 6 schematically illustrates a state of a USB port connection device in accordance with an embodiment of the invention.

### DETAILED DESCRIPTION

The technical solutions of the embodiment of the invention will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

An embodiment of the invention provides a USB female end as illustrated in FIG. 1. The USB female end comprises: a female end body 1, and the female end body 1 comprising a receptacle 11; two solenoid switches 3 respectively located on two opposite sides of the receptacle 11, each solenoid switch 3 comprising at least one movable core 31; through holes corresponding to the movable cores 31 in one-to-one correspondence disposed on side walls of the receptacle 11, each solenoid switch 3, when being energized, controlling said at least one movable core 31 to protrude and pass through the through hole; a switch controlling ON/OFF of a power supply of the solenoid switches 3; a signal acquisition unit electrically connected to an interface power source of the USB female end, r acquiring potential information of the interface power source of the USB female end and generating a corresponding potential signal; a control unit connected to the signal acquisition unit, and controlling the switch to enable the power supply of the solenoid switch 3 when the potential signal is a high potential signal or disable the power supply of the solenoid switch 3 when the potential signal is a low potential signal.

For the convenience of the describing the invention, the mechanical structure of the solenoid switch and working principles of the signal acquisition unit and the control unit for controlling the solenoid switch will be briefly described herein.

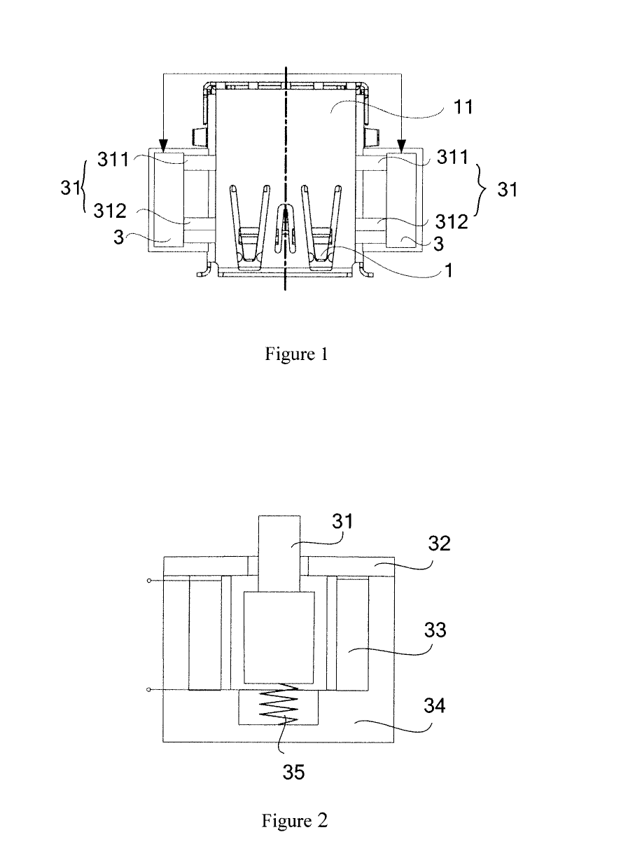

FIG. 2 schematically illustrates a configuration of a solenoid switch as provided by an embodiment of the invention. As illustrated in FIG. 2, a solenoid switch mainly comprises: a seat 34, a reset spring 35, a solenoid coil 33, a fixed core 32 and a movable core 31.

When using the above USB female end, in the case that the USB female end and the USB male end are not connected, the solenoid switch 3 is under inactive state. At this point, the movable core 31 of the solenoid switch 3 is at its initial position, and the movable core 31 does not pass through the corresponding through hole. When the USB male end is plugged into the USB female end and a signal connection is established, the potential information of the interface power source of the USB female end is a high level. The signal acquisition unit acquires the potential information of the interface power source of the USB female end and generates a high potential signal. The control unit controls the switch to enable the power supply of the solenoid switch 3 according to the high potential signal. At this point, the solenoid coil 33 of the solenoid switch 3 becomes active, the movable core 31 and the fixed core 32 contact with each other, thereby realizing lock. Meanwhile, the movable core 31 passes through the corresponding through hole and locks the USB male end. In comparison with conventional technologies, the embodiment of the invention further confines the left and right sides of the USB male end, thereby improving the firmness of the connection between the USB male and the USB female. When it is about to remove the USB male from the USB female, the potential information of the interface power source of the USB female end becomes a low level. The signal acquisition unit acquires the potential information of the interface power source of the USB female end and generates a low potential signal, according to which the control unit controls the switch to disable the power supply of the solenoid switch 3. At this point, the solenoid coil 33 of the solenoid switch 3 becomes inactive, the movable core 31 separates from the fixed core 32 due to the action of the reset spring 35 and unlocks with each other, and the USB male end now may be removed from the USB female end in a normal way.

It can be seen that the USB female end provided by the embodiment improves the firmness of the connection between the USB male end and USB female end, which in turn ensures the reliability of the circuit.

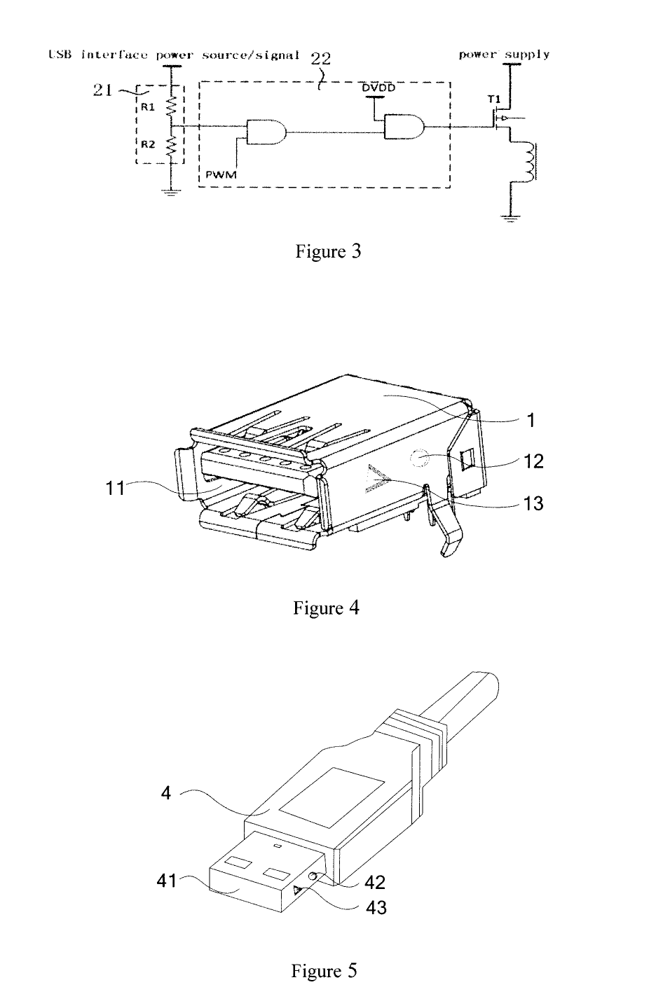

FIG. 3 illustrates the signal acquisition unit 21 and the control unit 22 as provided by the embodiment of the invention. As illustrated in FIG. 3, the signal acquisition unit 21 comprises a first resistor R1 and a second resistor R2, the control unit 22 comprises a DVDD AND gate, the switch is a MOS switch transistor T1. One terminal of the first resistor R1 is electrically connected to the interface power source of the USB female end, the other terminal is electrically connected to one terminal of the second resistor R2 and a first input of the DVDD AND gate, the output of the DVVD AND gate is electrically connected to the MOS switch transistor T1. The MOS switch transistor T1 as a switch element also works under two states of ON and OFF. As the MOS switch transistor T1 is a voltage-controlled element, its work state is mainly decided by the gate-source voltage VGS. The MOS switch transistor T1 has a transition period when switching between the ON/OFF states, but its dynamic characteristics is mostly dependent on time required to charge/discharge the stray capacitance related to the circuit, while the time for accumulating/dissipating charges by the MOS switch itself is very short when the MOS switch transistor is turned ON/OFF. The MOS transistor is also a three-terminal voltage-controlled element, the three terminals being G, D, S, which are equivalent to the three electrodes B, C, E of a regular transistor. The voltage VGS (=VG−VS) controls the ON/OFF state of the MOS switch transistor T1. When VSG is larger than Von (threshold voltage, about 2-4V for NMOS and −2˜−4V for PMOS), the MOS switch transistor is turned on, and the channel between the D and S electrodes is conducted, the voltage drop being zero, and the resistance being very small, normally less than one ohm. Similarly, the MOS switch transistor is turned off when VGS is smaller than Von. The potential information of the interface power source of the USB female end is acquired through the first resistor R1 and the second resistor R2. Based on the potential information, the potential signal is generated and is transmitted to the AND gate. The AND gate controls the MOS switch transistor T1 to turns on/off, thereby enabling/disabling the power supply of the solenoid switch 3, based on the high/low level of the received potential signal.

Preferably, the control unit 22 may further comprise a PWM, which is electrically connected to a second input of the AND gate and for controlling the potential signal received by the AND gate and stabilizing the signal. Power Width Modulation (PWM) is a method for digitally encoding the analog signal level. By means of a high-resolution counter, the duty cycle of a square wave is modulated to encode a signal level of a specific analog signal. However, as a full scale DC power is either totally ON or totally OFF at any give time, the PWM signal is still a digital signal. The voltage or current source is applied to the analog load in the form of a repeated pulse sequence of ONs or OFFs. When it is ON, the DC power is supplied to the load; when it is OFF, the power is turned off. As long as the bandwidth is wide enough, any analog values can be encoded using PWM.

When the USB male end is plugged into the USB female end and a signal connection is established, the potential information of the interface power source of the USB female end is a high level, the potential information of the interface power source of the USB female end is acquired via the resistors R1 and R2 and a high potential signal is generated. The generated high potential signal is transmitted to the AND gate via the PWM, the AND gate controls the MOS switch transistor T1 to enable the power supply of the solenoid switch 3. At this point, the solenoid coil 33 of the solenoid switch 3 becomes active, the movable core 31 and the fixed core 32 contact with each other, thereby realizing locking. It is understandable that the cross sections of the moving cores and the shapes of the through holes may be defined according to design requirement and actual need and may be a circle, a triangle, a quadrangle or other shapes. For example, FIG. 1 illustrates the two pairs of movable cores, wherein a cross section of one pair of movable cores 312 is triangular, and a cross section of the other pair of movable cores 311 is circular. Accordingly, as illustrated in FIG. 4, through holes corresponding to the triangular cross-sectioned movable cores 312 are triangular through holes 13, through holes corresponding to the circular cross-sectioned movable cores 311 are circular through holes 12. Naturally, it can be understood that the cross sections of the two pair of movable cores may have the same shape.

When the solenoid coil 33 of the solenoid switch starts to work, the movable core 31 and the fix core 32 contact with each other. The triangular cross-sectioned movable core 312 of the solenoid switch 3 passes through the triangular through hole 13, and the circular cross-sectioned movable core 311 passes through the circular through hole 12. The movable core 311 and the movable core 312 lock the USB male end, realizing confinement to both side walls of the plug, thereby improving the firmness of the connection between the USB male end and the USB female end.

An embodiment of the invention provides a USB male end used with the above USB female end. As illustrated in FIG. 5, the USB male end comprises a male end body 4, the male end body 4 further comprising a plug 41, wherein fixing holes in one-to-one correspondence with the through holes on the side walls of the receptacle 11 are disposed on two side walls of the plug 41.

When being used, as the USB male end is plugged into the receptacle of the USB female end, the potential information of the interface power source of the USB female end is a high level, the potential information of the interface power source of the USB female end is acquired via the resistors R1 and R2 and a high potential signal is generated. The generated high potential signal is transmitted to the AND gate via the PWM, the AND gate controls the MOS switch transistor T1 to enable the power supply of the solenoid switch 3. At this point, the solenoid coil 33 of the solenoid switch 3 becomes active, the movable core 31 contacts the fixed core 32 and locks with each other. The movable core 31 passes through the corresponding through hole and then mates with the fixing hole on the two side walls of the USB male plug, realizing confinement to both side walls of the plug, thereby improving the firmness of the connection between the USB male end and the USB female end.

Therefore, the USB male end with the above configuration as provided by the invention improves the firmness of the connection between the USB male end and the USB female end, and ensures the reliability of the USB connection.

For better complementation with the USB female end, for example, when there are two pairs of fixing holes, one pair may be triangular fixing holes 43, and the other pair may be circular fixing holes 42. The fixing holes can of course have some other shapes, such as a quadrangle, which will not be elaborated here.

Alternatively, the triangular fixing holes 43 may be through holes and the circular fixing holes 42 may be blind holes. When being used, as the USB male end and the USB female end are connected, the potential information of the interface power source of the USB female end is high, the potential information of the interface power source of the USB female end is acquired via the resistors R1 and R2 and a high potential signal is generated. The generated high potential signal is transmitted to the AND gate via the PWM, the AND gate controls the MOS switch transistor T1 to enable the power supply of the solenoid switch 3. At this point, the solenoid coil 33 of the solenoid switch 3 becomes active, the movable core 31 contacts the fixed core 32 and locks with each other. The triangular cross-sectioned movable core 312 of the solenoid switch 3 passes through the triangular through hole 13 and then mates with the triangular fixing hole 43 on the USB male end, thereby confining the movement of the USB male end in the upwards/downwards, forwards/backwards directions. Meanwhile, the circular cross-sectioned movable core 311 passes through the circular through hole 12 and then mates with the circular fixing hole 42 on the USB male, thereby confining the movement of the USB male end in the left/right directions. When it is about to remove the USB male from the USB female, the potential information of the interface power source of the USB female end is of a low level, the potential information of the interface power source of the USB female end is acquired via and the resistors R1 and R2 and a low potential signal is generated. The generated low potential signal is then transmitted to the AND gate via the PWM, the AND gate controls the MOS switch transistor T1 to disable the power supply of the solenoid switch 3. At this point, the solenoid coil 33 of the solenoid switch 3 becomes inactive, the movable core 31 separates from the fixed core 32 due to the action of the reset spring 35 and unlocks with each other, and the USB male end may be removed from the USB female end in a normal way.

It can be understood that the two pairs of fixing holes may both be blind holes.

In the case that the fixing holes are a pair of triangular blind holes, when being used, as the USB male end and the USB female end are connected, the potential information of the interface power source of the USB female end is a high level, the potential information of the interface power source of the USB male end is acquired via the resistors R1 and R2 and a high potential signal is generated. The generated high potential signal is transmitted to the AND gate via the PWM, the AND gate controls the MOS switch transistor T1 to enable the power supply of the solenoid switch 3. At this point, the solenoid coil 33 of the solenoid switch 3 becomes active, and the movable core 31 contacts the fixed core 32 and locks with it. The triangular cross-sectioned movable core 312 of the solenoid switch 3 passes through the triangular through hole 13 and then mates with the triangular blind hole 43 on the USB male, thereby confining the movement of the USB male end in the upwards/downwards, forwards/backwards and left/right directions. It may also improve the firmness of the connection between the USB male end and the USB female end, and ensure the reliability of the circuit.

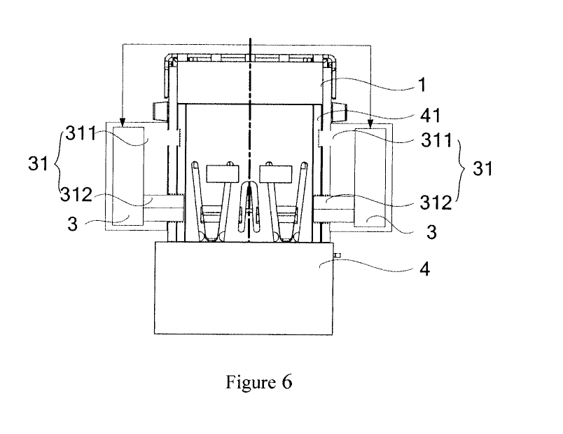

An embodiment of the invention further provides a USB port connection device as illustrated in FIG. 6. The USB port connection device comprises the USB female end and the USB male end as described in the above technical solutions. The device has good connection stability and ensures the reliability of the circuit.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. A USB female end comprising:
a female end body, which comprising a receptacle;
two solenoid switches, respectively located on two opposite sides of the receptacle, each solenoid switch comprising at least one movable core;
through holes, disposed on side walls of the receptacle corresponding to said at least one movable core in one-to-one correspondence, each solenoid switch, when being energized, controlling said at least one movable core to protrude and pass through the through hole;
a switch, controlling ON/OFF of a power supply of the solenoid switches;
a signal acquisition unit, electrically connected to an interface power source of the USB female end, acquiring potential information of the interface power source of the USB female end and generating a corresponding potential signal;
a control unit, connected to the signal acquisition unit, controlling the switch to enable the power supply of the solenoid switches when the potential signal is a high potential signal or disable the power supply of the solenoid switches when the potential signal is a low potential signal.

2. The USB female end of claim 1, wherein the signal acquisition unit comprises a first resistor and a second resistor, the control unit comprises a DVDD AND gate, the switch is a MOS switch transistor, and wherein:
one terminal of the first resistor is electrically connected to the interface power source of the USB female end, the other terminal is electrically connected to one terminal of the second resistor and a first input of the AND gate, the output of the AND gate is electrically connected to the MOS switch transistor.

3. The USB female end of claim 2, wherein the control unit further comprises a Pulse Width Multiplier (PWM), which is electrically connected to a second input of the AND gate.

4. The USB female end of claim 3, wherein said at least one movable core comprises two pairs of movable cores, each cross section of one pair of movable cores is triangular, each cross section of the other pair of movable cores is circular; and
the through holes corresponding to the triangular cross-sectioned movable cores are triangular through holes, the through holes corresponding to the circular cross-sectioned movable cores are circular through holes.

5. A USB male end used with the USB female end of claim 1 comprising: a male end body; the male end body further comprising a plug; wherein fixing holes are disposed on two side walls of the plug in one-to-one correspondence with the through holes on the side walls of the receptacle of the USB female end.

6. The USB male end of claim 5, wherein the fixing holes comprise two pairs of fixing holes, wherein one pair of fixing holes are triangular fixing holes, the other pair of fixing holes are circular fixing holes.

7. The USB male end of claim 6, wherein the triangular fixing holes are through holes and the circular fixing holes are blind holes.

8. The USB male end of claim 6, wherein the two pairs of fixing holes are blind holes.

9. A USB port connection device comprising the USB female end of claim 1 and the USB male end of claim 5.
